(19) United States
(12) Patent Application Publication
(10) Pub. No.: US 2005/0238159 A1
(43) Pub. Date: Oct. 27, 2005

(54) Automatic number storage for directory assistance services

(76) Inventor: Victoria Marie Halsell, Bolingbrook, IL (US)

Correspondence Address: Lucent Technologies Inc.;Docket Administrator, Room 3J-219, 101 Crawfords Corner Road, Holmdel, NJ, 07733-3030, US

(21) Appl. No.: 10/832,743

(22) Filed: Apr. 26, 2004

(51) Int. Cl. H04M 3/42

(52) U.S. Cl. 379/218.01

(57) ABSTRACT

An automatic storage option for directory assistance callers is disclosed, whereby an operator services system offers to store directory numbers (“target numbers”) identified coincident to directory assistance calls. Responsive to a command issued from a calling terminal invoking the automatic storage option, the target numbers are stored in an internal memory of the calling terminal or in a subscriber database remote from the calling terminal. Thereafter, sometime after the directory assistance call is completed, the calling terminal may consult its internal memory or access the centralized database to retrieve and call the target number.

### FIELD OF THE INVENTION

This invention relates generally to telecommunication networks and, more particularly, to a directory assistance feature for wireless and/or wireline telecommunication networks.

### BACKGROUND OF THE INVENTION

Directory assistance services are well known in which a caller (using, for example, a wireless or wireline phone) dials an access code (e.g., “411”) to request directory assistance from an operator. A caller may use directory assistance, for example, to request from an operator a directory number associated with a person or business at a particular location. Typically, the operator initiates a search for the number, using printed directories or a computer database; and, once the number is identified, the operator connects the caller to an automated response unit to communicate a synthesized recitation of the identified number. Optionally, the operator may offer to automatically connect the caller to the identified directory number (i.e., without requiring the caller to dial the identified directory number), typically for a small fee. This service is known as directory assistance call completion (“DACC”). As will be appreciated, the functions of the operator may be performed by one or more human operators or may be automated in whole or in part. Similarly, a human operator rather than an automated response unit may perform the function of communicating the identified number to the caller.

A problem that arises is that callers using directory assistance (with or without DACC) may be unmotivated or unable to make a note of the number identified by directory assistance yet may need to retrieve the number for future use. For example, a caller may dial or automatically connect to the identified number only to receive no answer, a busy signal or an invitation to leave a voicemail message. In such case, the caller may wish to re-attempt the call at a later time but, unless the caller memorized or took time to make note of the number (and is able to retrieve the note), the caller must dial 411 yet again and incur another fee to obtain the number. Indeed, even if the caller successfully connects to a directory assistance identified number on a first attempt, the caller may wish to make further call(s) to the identified number without having to memorize or make note of the number and without having to dial 411 and incur associated fees on each attempt.

Accordingly, there is a need to provide an enhancement to customary directory assistance services whereby a caller/customer having obtained a directory number using directory assistance may later retrieve the number without making further directory assistance requests.

### SUMMARY OF THE INVENTION

This need is addressed and a technical advance is achieved in the art by a feature whereby a directory assistance customer may invoke an automatic storage option to automatically store one or more directory numbers obtained via directory assistance for later retrieval as may be desired to make future call(s) without the need for further directory assistance requests. Optionally, the automatic storage option may cause the directory numbers to be stored in memory of a communication device (e.g., mobile phone) or in a centralized database.

In one embodiment, there is provided a method performed by an operator services system coincident to receiving a directory assistance request from a calling terminal. After first identifying a target directory number for the caller, the operator services system informs the caller that an automatic storage option is available to store the target number. The automatic storage option is invoked responsive to a command issued from the calling terminal. If the calling terminal invokes the automatic storage option, the operator services system stores the target directory number in an internal memory of the calling terminal or in a subscriber database remote from the calling terminal.

In another embodiment, there is provided a method comprising a calling terminal issuing a command to store a target directory number identified coincident to a directory assistance call. Responsive to the calling terminal issuing the command, the target directory number is received in a memory element accessible by the calling terminal. The memory element may comprise an internal memory of the calling terminal including stored directory numbers (e.g., address book) or it may comprise a centralized database. Thereafter, sometime after the directory assistance call is completed, the calling terminal may consult the address book or access the centralized database to retrieve and call the target directory number.

In still another embodiment, there is provided a method comprising a switching center receiving a request from a calling terminal to access a stored directory number (“target number”) obtained coincident to a directory assistance call. Responsive to the request, the switching center accesses a centralized database to retrieve the target number and sends a message to the calling terminal including indicia of the target number. Optionally, the switching center exchanges one or more messages with the calling terminal to help identify the target number from among a plurality of other number stored in the centralized database. Having identified the target number, the switching center optionally informs the caller that a connection option is available to connect the calling terminal to the target number. The connection option is invoked responsive to a command issued from the calling terminal.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method for providing directory assistance including an automatic storage option whereby an identified number may be stored for later retrieval by a customer;

FIG. 3 is a flowchart of a method for retrieving and optionally calling a specified target directory number obtained via an automatic storage option and stored in a calling terminal device according to an embodiment of the invention; and

FIG. 4 is a flowchart of a method for retrieving and optionally calling a specified target directory number obtained via an automatic storage option and stored in a centralized database according to an embodiment of the invention.

### DESCRIPTION OF THE PREFERRED EMBODIMENT(S)

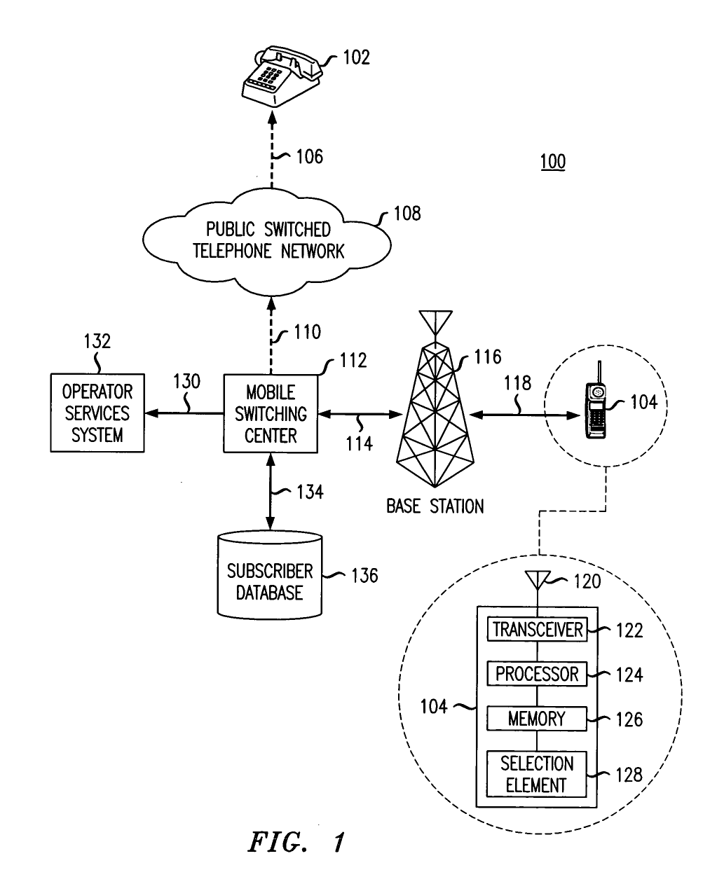

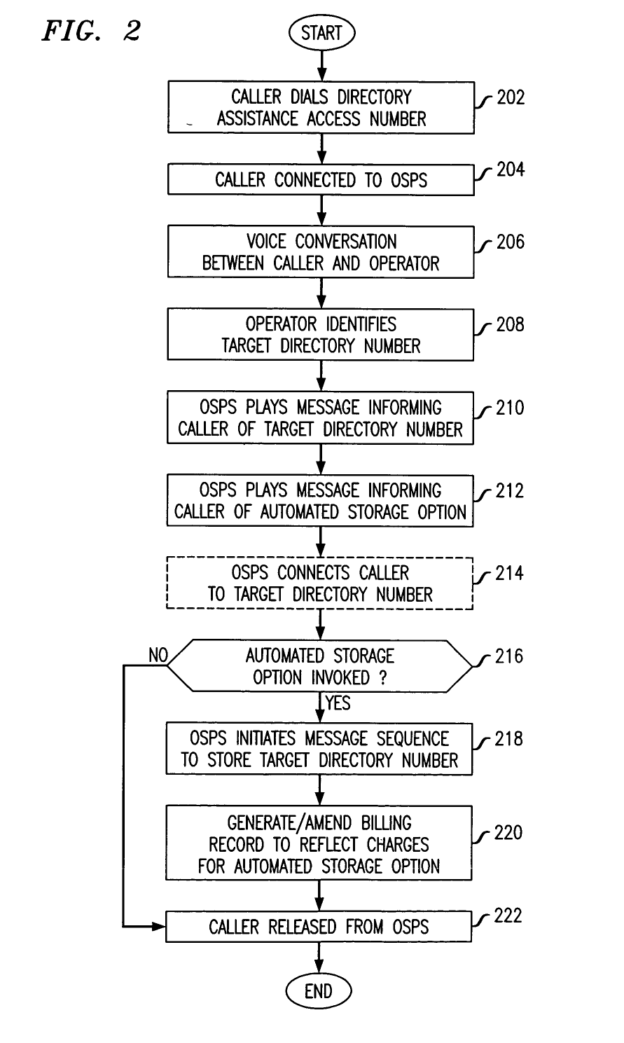

FIG. 1 shows a communication system 100 according to an exemplary embodiment of the invention that is operable to support an automatic storage option for directory assistance customers. Generally, as will be described in greater detail in relation to FIG. 2, the automated storage option enables authorized subscribers to store numbers obtained via directory assistance for later retrieval as may be desired to make future call(s) without the need for further directory assistance requests.

In one embodiment, the directory assistance customers initiate the automatic storage option coincident to making a directory assistance call, which may be made using wireline or wireless phones, fax machines, personal digital assistants (PDAs), personal computers or generally any communication device (hereinafter, “calling terminal”) that is capable of initiating calls. For convenience, only one each of a wireline calling terminal 102 and wireless calling terminal 104 is shown. However, as will be appreciated, the communication system 100 is operable to support directory assistance calls from virtually any type of calling terminal.

The wireline terminal 102 is connected by link 106 to a network 108 (as shown, the Public Switched Telephone Network (PSTN)). The network 108 may be implemented using any appropriate transmission, switching and routing technologies, including but not limited to Internet Protocol (IP) and Asynchronous Transfer Mode (ATM) technologies. The network 108 is connected by link 110 to a switching element 112 (as shown, a mobile switching center (MSC)).

The MSC 112 is a call processing control entity that routes calls, as may be appropriate, to or from mobile terminals such as calling terminal 104. In the case of a directory assistance call from calling terminal 104, for example, the MSC 112 routes the call from a calling terminal 104 to an operator terminal (not shown) residing in operator services system 132. The MSC 112 is a functional element that may reside in a single switch or may be distributed among multiple switches and/or locations. The MSC 112 may comprise, for example, an AUTOPLEX™ switching system, available from Lucent Technologies, Inc. The MSC 112 includes a memory and processor (not shown), for storing and executing software routines for processing and switching calls and for providing various call features to calling or called parties. The MSC 112 may be configured for operation with generally any suitable circuit, cell, or packet switching technology.

The MSC 112 is connected by link 114 to a base station 116, which is connected by wireless link 118 to the wireless terminal 104. The wireless link 118 may implement air interface technologies including but not limited to, CDMA, TDMA, GSM, UMTS or IEEE 802.11.

As depicted in FIG. 1 in block view, the calling terminal 104 includes an antenna 120, radio transceiver 122, processor 124, memory 126 and selection element 128. The various elements of the calling terminal are functional elements that may reside in one or more physical devices and, in some implementations, might be reside or operate remotely from the calling terminal 104.

The radio transceiver 122 is coupled to the processor 124 and antenna 120 to enable the calling terminal 104 to exchange information (e.g., voice, video, data, text, etc.) with other elements of the communication system 100 via the wireless link 118. In one embodiment, the transceiver is used to enable the calling terminal 104 to make a directory assistance call and exchange messages with the MSC 112 and operator services system 132 coincident to the directory assistance call.

The processor 124 comprises a microprocessor and a digital signal processor for controlling the various elements of the calling terminal 104 and for communicating with the elements of the communication system 100 including, without limitation, the MSC 112 and the operator services system 132.

The memory 126 comprises a random access memory (RAM), read-only memory (ROM), programmable read-only memory (PROM) and or a magnetic disk to store software algorithms and data used by the processor 124 during operation of the calling terminal 104. In one embodiment, the memory 126 includes lists of numbers obtained for calling terminal 104 coincident to a directory assistance call and stored via the automatic storage option.

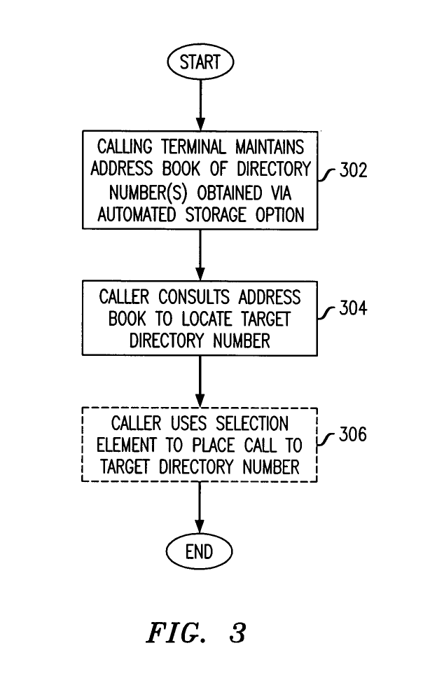

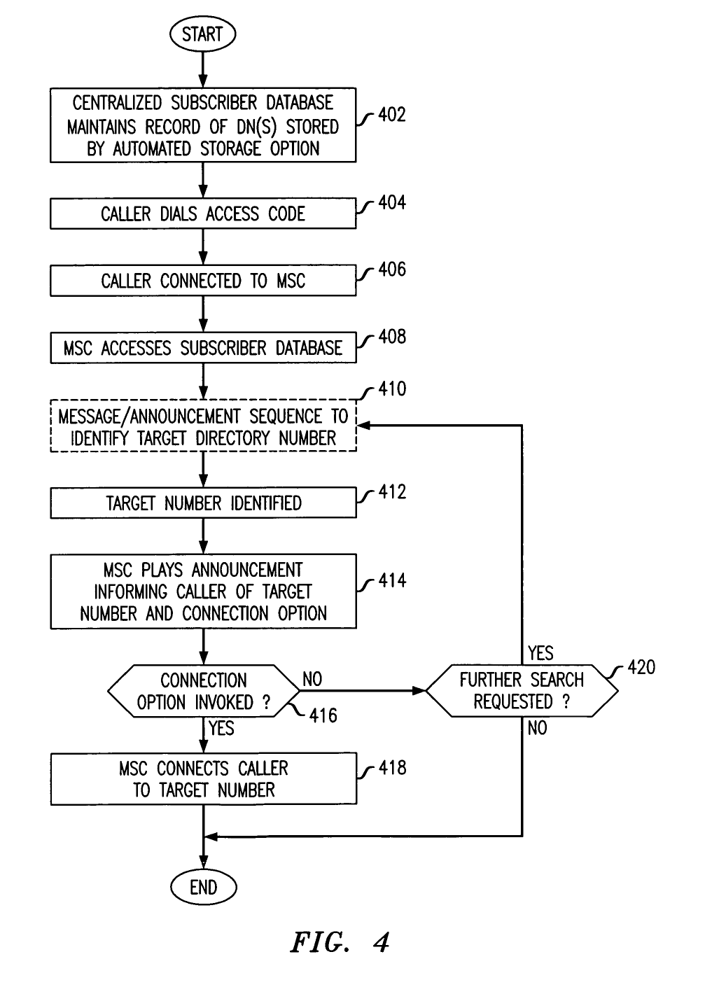

The selection element 128 comprises a user input device or combination of such devices, including, for example, keypad, display window, microphone, computer mouse or equivalent that enables the operator of the calling terminal to initiate a directory assistance call and to select an automatic storage option coincident to the directory assistance call to store an identified number obtained via directory assistance. Advantageously, the selection element 128 further enables the operator of the calling terminal to retrieve from memory and select certain directory numbers obtained previously via the automatic storage option. In one embodiment (FIG. 3), the directory numbers are stored (and later retrieved) from memory 126 of the calling terminal. In another embodiment (FIG. 4), the directory numbers are stored (and later retrieved) from a centralized database (i.e., remote from the calling terminal), such as the subscriber database 136. In either case, the ability to retrieve selected directory assistance numbers from memory enables the operator of the calling terminal to place calls to the selected numbers at any convenient time (or multiple times) after completion of the directory assistance call.

The operator services system 132 includes a plurality of operator positions, directory databases, automated voice response system and messaging system (none shown) such as is known in the art to facilitate directory assistance services when invoked by a customer dialing an access code (e.g., 411). For convenience, the operator services system will hereinafter be identified by the acronym “OSPS,” referring to “Operator Services Position System.” The OSPS 132 is connected by link 130 to the MSC 112. The OSPS 132 may also be connected to a subscriber database 136, either directly or via the MSC 112 and link 134, as shown.

The subscriber database 136 includes a list of subscriber directory numbers and associated information such as indicia of whether certain subscribers are authorized for an automated storage option. In one embodiment, the subscriber database includes lists of numbers obtained for various subscribers during a directory assistance call and stored via the automatic storage option.

Turning now to FIG. 2, there is shown a flowchart of a method that may be implemented to exercise an automatic storage option during a directory assistance call. The steps of FIG. 2 are implemented, where applicable, using stored software routines within the calling terminal 104, MSC 112 and/or OSPS 132. As will be appreciated, with respect to OSPS functions, the steps of FIG. 2 performed by human operators may be automated in whole or in part. Similarly, steps of FIG. 2 that are described as automated functions could alternatively be performed by human operators.

At step 202, a caller dials a directory assistance access number (e.g., 411) to initiate a directory assistance call. At step 204, the MSC 112 interprets the digits as a directory assistance call and connects the caller to the OSPS 132 where the call is routed to an available operator position. At step 206, the operator speaks with the caller to obtain information relevant to finding a particular directory number desired by the caller. For example, the caller may recite a name of a particular person or business and request the operator search for a directory number corresponding to the person or business. The operator searches for the number, typically using printed directories or a computer database. It is presumed at step 208, that the operator identifies the desired number (termed “target directory number”). At step 210, the operator connects the caller to an automated response unit of the OSPS to voice a synthesized recitation of the identified number and hence, inform the caller of the target directory number.

At step 212, the OSPS plays a message or sends a text message inviting the caller to exercise an automatic storage option if they wish to have the identified number automatically stored in memory. In one embodiment, the message at step 212 informs the caller of the identified number and informs the caller of a particular command (e.g., key or keystroke sequence) to invoke the automatic storage option. For example, a message may be played (or displayed) to the effect of:

“The number is 555-1234. If you wish to have this number stored for later retrieval, please press the pound key.”

As will be appreciated, the message may be varied as needed or desired by the service provider to accommodate different type(s) of calling parties, languages and so forth, and may be realized in different media (e.g., voice, video or text) depending on the implementation. Of course, the message may also be varied in content, for example, to inform the user of fees associated with the automatic storage option, or to prompt for different commands, keystrokes, and the like to exercise the automatic storage option. In one embodiment, the message at step 212 (or alternatively, a separate message) may invite the caller to exercise directory assistance call completion (DACC) to automatically connect the caller to the identified number. In such case, and if the caller exercises DACC, the OSPS connects the caller to the target number at step 214 as is known in the art.

At step 216, the OSPS determines whether or not the caller has invoked the automatic storage option. Thus, continuing the example where the caller is prompted to press the pound key to invoke the automatic storage option, the OSPS determines that the caller has invoked the automatic storage option if it receives the pound “command” issued from the calling terminal at step 216. Conversely, the OSPS determines that the caller has not invoked the automatic storage option if it does not receive the pound “command” issued from the calling terminal at step 216.

If the automatic storage option is invoked, the OSPS initiates a message sequence at step 218 to store the target directory number. In one embodiment an exercise of the automatic storage option causes the OSPS to store the target number in the memory 126 of the calling terminal. In another embodiment, exercise of the automatic storage option causes the identified number to be stored in a centralized database, such as the subscriber database 136. In the former case (storage in memory 126), the OSPS initiates a message sequence with the MSC 112 and calling terminal 104 to store the target number in memory 126. In the latter case (storage in subscriber database 136), the OSPS initiates a message sequence with the MSC 112 and subscriber database 136 to store the target number. As will be appreciated, the message sequence may be implemented using any of several protocols, formats, or the like, either presently existing or devised in the future. Suffice it to say the message sequence will result in the calling terminal 104 (or the subscriber database 136, as the case may be) receiving the target number from the OSPS.

In one embodiment, the message sequence at step 218 (or alternatively, a separate message sequence) prompts the caller to enter a name associated with the number to simplify later retrieval by the caller. Alternatively or additionally, the OSPS may independently store a name associated with the number to facilitate later retrieval. Advantageously, the message sequence at step 218 will be concurrent with the directory assistance call (or if applicable, the ensuing DACC call to the target number) yet will use signaling that does not interfere with the directory assistance or DACC call.

At step 220, the OSPS generates or amends a billing record to bill the calling party for charges associated with the directory assistance call as may be appropriate. In one embodiment, the charges for directory assistance, automatic storage option or DACC accrue on a call-by-call basis. As will be appreciated, the charges associated with directory assistance calls and any incremental charges for invoking the automatic storage option or DACC, are determined by the service provider and may differ for different calling parties depending on their respective service subscriptions or their location. Alternatively or additionally, service provider(s) might provide a certain amount of “free” directory assistance, automatic number storage and/or DACC as a part of a basic subscription package, similarly to the manner in which wireless subscribers often receive a certain amount of “free” airtime minutes as a part of a basic service contract.

At step 222, after exercise of the automatic storage option at steps 218, 220, or after the caller has declined the automatic storage option at step 216, the caller is released from OSPS.

Now turning to FIG. 3, there is shown a flowchart of a method that may be implemented to retrieve from internal memory 126 of a calling terminal (e.g., wireless terminal 104) and select certain directory numbers obtained previously via the automatic storage option. The steps of FIG. 3 are implemented using stored software routines within the calling terminal 104 responsive to operator commands, keystrokes or the like executed from the calling terminal.

The method presumes at step 302 that various directory numbers previously obtained by the automatic storage option are stored in internal memory 126 of the calling terminal. In one embodiment, the numbers are stored in the form of an “address book” (not shown) of directory numbers. The numbers of the address book stored responsive to the automatic storage option may be separate from or commingled with numbers manually entered by the operator or entered by other means. Further, the numbers stored responsive to the automatic storage option may be “flagged” with an icon, distinctive text or other means to identify them as automatically stored numbers and to distinguish them from numbers stored by other means. The numbers stored responsive to the automatic storage option may or may not be further identified by a name, date or other characteristic information to facilitate later retrieval by the operator.

At step 304, the operator of the calling terminal consults the address book for a particular number (“target number”) previously obtained via the automatic storage option. Presuming the operator finds the target number, the operator at step 306 optionally uses the selection element 128 of the calling terminal to select and place a call to the target number. Thereafter, signaling occurs between the calling terminal 104 and MSC 112, as known in the art, to set up resources for the call and connect the calling terminal to the target number.

As will be appreciated, step 306 may be implemented using any of several different key sequences or the like. As one example, the operator might scroll through a series of numbers of the address book shown in a display window of the calling terminal and select the desired number by pressing a designated key (e.g., a “select” key), then place a call to the designated number by pressing a second key (e.g., a “send” key). Still other alternatives might allow for the user to select and call the target number using a single designated key, an alternative key sequence, voice commands, etc. or a combination thereof.

Now turning to FIG. 4, there is shown a flowchart of a method that may be implemented for a calling terminal to retrieve and select from a database remote from the calling terminal (e.g., subscriber database 136) certain directory numbers obtained previously via the automatic storage option. The steps of FIG. 4 are implemented using stored software routines within the calling terminal 104, MSC 112 or subscriber database 136 responsive to operator commands, keystrokes or the like executed from the calling terminal.

The method presumes at step 402 that various directory numbers previously obtained by the automatic storage option are stored in a centralized database (e.g., subscriber database 136). In one embodiment, the database 136 includes numbers obtained via the automatic storage option by a plurality of subscribers. The numbers obtained for each respective subscriber via the automatic storage option are preferably mapped to the directory number, subscriber ID or other indicia of the subscriber to distinguish them from numbers associated other subscribers and to facilitate later retrieval of the numbers by the appropriate subscribers. The numbers stored responsive to the automatic storage option may or may not be further identified by a name, date or other characteristic information to facilitate later retrieval by the operator.

At step 404, a caller dials an access code or designated directory number to initiate retrieval of a directory assistance number stored in the centralized database 136. The access code or designated directory number initiates a signaling sequence causing the calling terminal to connect to the MSC 112 at step 406 and the MSC to access the subscriber database 136 at step 408.

Optionally, at step 410, the MSC 112 plays a message/announcement (or sequence of messages/announcements) prompting the caller for information to assist in finding a particular directory number stored in the centralized database 136. This may be necessary, for example, for subscribers having multiple directory assistance numbers stored in the centralized database 136. For example, the MSC 112 may prompt the caller to enter the first few characters of a stored name. Alternatively or additionally, the MSC may cause stored numbers associated with the caller to be downloaded from the centralized database 136 for display and selection by the calling terminal.

At step 412, the MSC identifies the target number, either independently or responsive to information provided by the caller. At step 414, the MSC plays a message informing the caller of the target number and inviting the caller to exercise a connection option if they wish to automatically connect to (or “call”) the target number. The connection option is similar to DACC except that it is implemented by the MSC 112 in conjunction with retrieval of a target number from a centralized database, whereas DACC is implemented by the OSPS in conjunction with a directory assistance call.

For example, a message may be played (or displayed) to the effect of:

“The number retrieved is 555-5678. If you wish to connect to this number, please press the star key.”

As will be appreciated, the message may be varied as needed or desired by the service provider to accommodate different type(s) of calling parties, languages and so forth, and may be realized in different media (e.g., voice, video or text) depending on the implementation. Of course, the message may also be varied in content, for example, to inform the user of fees associated with the connection option, or to prompt for different commands, keystrokes, and the like to exercise the connection option.

If the caller invokes the connection option, determined at block 416, the MSC sets up resources for the call and connects the caller to the target number at step 418. If the caller does not invoke the connection option, the process returns to step 410 if further search is required or the process ends if further search is not required. The MSC 112 makes the determination of whether search is required at block 420 either independently or responsive to information provided by the caller. Further search may be required, for example, if multiple numbers are associated with the subscriber and the MSC retrieved an improper number on a previous attempt.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising an operator services system, responsive to receiving a directory assistance request from a caller associated with a calling terminal, performing steps of:
identifying a target directory number;
sending a message to the calling terminal indicating availability of an automatic storage option whereby the operator services system offers to store the target directory number for the caller;
receiving a command issued from the calling terminal invoking the automatic storage option; and
responsive to receiving the command, storing the target directory number.

2. The method of claim 1, wherein the step of storing the target directory number comprises storing the target directory number in an internal memory of the calling terminal.

3. The method of claim 1, wherein the step of storing the target directory number comprises storing the target directory number in a subscriber database remote from the calling terminal.

4. The method of claim 1, further comprising generating a billing record to reflect charges associated with the calling terminal invoking the automatic storage option.

5. The method of claim 1, wherein the step of sending a message comprises sending a voice message to the calling terminal indicating availability of an automatic storage option.

6. The method of claim 1, wherein the step of sending a message comprises sending a text message to the calling terminal indicating availability of an automatic storage option.

7. The method of claim 1, wherein the step of sending the message comprises sending an instruction to the caller of the command needed to invoke the automatic storage option.

8. A method comprising:
issuing, from a calling terminal, coincident to a directory assistance call whereby an operator services system identifies a target directory number, a command for the operator services system to store the target directory number; and
responsive to issuing the command, receiving the target directory number in a memory element accessible by the calling terminal.

9. The method of claim 8, wherein the step of receiving the target directory number comprises receiving the target directory number in an internal memory of the calling terminal defining an address book of stored directory numbers.

10. The method of claim 9, further comprising, sometime after the directory assistance call is completed:
consulting the address book to locate the target directory number; and
placing a call to the target directory number.

11. The method of claim 8, wherein the step of receiving the target directory number comprises receiving the target directory number in a centralized database accessible by the calling terminal.

12. The method of claim 11, further comprising, sometime after the directory assistance call is completed:
accessing the centralized database to retrieve the target directory number; and
placing a call to the target directory number.

13. A method comprising a switching center performing steps of:
receiving a request from a calling terminal to access a stored directory number obtained coincident to a directory assistance call, the directory number defining a target number;
accessing a centralized database to retrieve the target number; and
sending a message to the calling terminal including indicia of the target number.

14. The method of claim 13 further comprising:
exchanging one or more messages with the calling terminal to help identify the target number from among a plurality of other number stored in the centralized database.

15. The method of claim 13 further comprising:
sending a message to the calling terminal indicating availability of a connection option whereby the switching center offers to connect the calling terminal to the target number;
receiving a command issued from the calling terminal invoking the connection option; and
responsive to receiving the command, connecting the calling terminal to the target number.
